(19) United States
(12) Patent Application Publication
(10) Pub. No.: US 2013/0156929 A1
(43) Pub. Date: Jun. 20, 2013

(54) GREEN TEA BEVERAGE PACKED IN CONTAINER AND METHOD OF MANUFACTURING THE SAME

(71) Applicants: Masami Sasame, Makinohara-shi (JP); Kenji Shimaoka, Makinohara-shi (JP); Junko Iida, Makinohara-shi (JP); Kazunobu Tsuru, Makinohara-shi (JP)

(72) Inventors: Masami Sasame, Makinohara-shi (JP); Kenji Shimaoka, Makinohara-shi (JP); Junko Iida, Makinohara-shi (JP); Kazunobu Tsuru, Makinohara-shi (JP)

(73) Assignee: ITO EN, LTD.

(21) Appl. No.: 13/818,566

(22) PCT Filed: Aug. 31, 2010
(86) PCT No.: PCT/JP2010/064833

§ 371 Date: Feb. 22, 2013

(51) Int. Cl. A23F 3/16

(52) U.S. Cl. CPC A23F 3/163
USPC 426/597; 426/495

(57) ABSTRACT

The present invention provides a new green tea beverage packed in a container that has a good balance of taste and odor, and has refreshing aftertaste with nutritious taste, and has odor note and nutritious taste even in a cold state.

The green tea beverage packed in a container of the present invention has a sugar concentration, which is the sum of a reducing sugar concentration and a non-reducing sugar concentration, being 75 ppm to 250 ppm, a ratio of the non-reducing sugar concentration relatively to the reducing sugar concentration (non-reducing sugar/reducing sugar) being 2.0 to 8.0, and a particle size of the cumulative 90% by mass (D90) being 2500 μm or more.

### TECHNICAL FIELD

The present invention relates to a green tea beverage packed in a container that contains a green tea extraction liquid that is extracted from a green tea as a major component, which is filled into a plastic bottle, a can or the like.

### BACKGROUND ART

In connection with the flavor of a green tea beverage, various inventions have been suggested from various view points such as elevation of original odor and good taste of a green tea, or catering for consumers' tastes, and the like.

For example, Patent Document 1 discloses a method of manufacturing a water-soluble tea extract that gives flavor by adding enzymes to a tea extraction residue and hydrolyzing it.

Patent Document 2 discloses a tea beverage that is obtained by two-step extraction of performing extraction with tea leaves in 80 to 100° C. hot water for 30 to 90 seconds and cooling the extract to 30 to 50° C. by adding cold water, and then performing extraction for 120 to 300 seconds, wherein the tea beverage has high odor in the same degree as that of a high temperature-extracted tea beverage, and deep delicious taste, strong richness, and weak sourness in the same degree as that of a low temperature-extracted tea beverage.

Patent Document 3 discloses a low temperature extraction method of preventing generation of off flavor, which is so-called retort smell that occurs at the time of sterilization treatment.

Patent Document 4 discloses a method of mixing extraction liquids of refined green tea (Gyokuro tea) and deep-steamed tea to improve the flavor.

In addition, Patent Document 5 discloses a method of manufacturing a product that has a balance of delicious taste and aroma by using at least 2 kinds or more of extraction water obtained through low temperature extraction and high temperature extraction.

Patent Document 6 suggests a method in which live tea leaves are roasted by an oven, whereby to boost the unique aroma of fired tea by heating and improve tea flavor.

Patent Document 7 suggests a method of manufacturing a green tea beverage packed in a tight-sealed container by blending a green tea extraction liquid, which is extracted from tea leaves (green tea) with the use of low temperature aqueous media such as 45 to 70° C. ion-exchanged water, with an extract extracted from live tea leaves with the use of hot water, in which the extract is blended as it is or in the form of a concentrate, and/or in the dried form, which is intended to provide a green tea beverage packed in a tight-sealed container, which has freshly-brewed tea aroma and balanced flavor.

In addition, Patent Document 8 discloses a method of manufacturing a green tea beverage that is excellent in flavor, and has good balance of aroma components, and creates no unpleasant sediments, which comprises two-divided tea extraction steps in which one step is to obtain a pressure-extraction liquid by subjecting green tea leaves to pressurized extraction (step A) and the other step is to obtain an ordinary pressure-extraction liquid by subjecting green tea leaves to ordinary pressure extraction and then to fine filtration (step B), and comprises a mixing step of mixing the pressure-extraction liquid and the ordinary pressure-extraction liquid obtained in each step in a mixing ratio that is determined on the basis of the weight of the live tea leaves (step C).

Patent Document 9 discloses a method of manufacturing a green tea beverage that appropriately has unique green tea odor, delicious taste, and richness, exhibits light greenish yellow of the color tone, is translucent, has no sediments even with long period storage. In the method, a green tea is subjected to extraction with warm water at a pH of 8.0 to 10.0, the resulting extraction liquid is adjusted to have a pH of 5.5 to 7.0 and a turbidity of 83 to 93% in terms of T % at 660 nm, and then it is filled into a package container which is then tightly sealed.

In addition, Patent Document 10 discloses a method of manufacturing a tea beverage that is excellent in flavor, particularly excellent in nutritious taste, which comprises (i) a step of bringing tea leaves into contact with saturated steam, to promote opening of the tea leaves in the low temperature extraction step, (ii) a step of subjecting the above-treated tea leaves to extraction using low temperature water, to obtain an extraction liquid, and (iii) a step of subjecting the above-mentioned extraction liquid to sterilization treatment.

Patent Documents 11 and 12 disclose a beverage packed in a container of which astringent taste and bitter taste are suppressed, in which the beverage packed in a container is obtained by blending a green tea extract containing high concentration of catechin with carbohydrate in a suitable ratio.

Patent Document 13 discloses a method of manufacturing a green tea beverage packed in a container that produces no sediments even with long period storage and is suitable for sale as a warm product. The method comprises an adsorption step of adding silica to a tea extraction liquid so that sediments components of the tea extraction liquid are adsorbed onto the silica and a kieselguhr filtration step of performing kieselguhr filtration with the use of acid-treated kieselguhr.

### PRIOR ART DOCUMENT

### Patent Document

Patent Document 1: Japanese Patent Application Laid-Open (JP-A) No. H4-228028
Patent Document 2: JP-A No. H6-303904
Patent Document 3: JP-A No. H6-343389
Patent Document 4: JP-A No. H8-126472
Patent Document 5: JP-A No. H11-56242
Patent Document 6: JP-A No. H11-262359
Patent Document 7: JP-A No. 2001-258477
Patent Document 8: JP-A No. 2001-286260
Patent Document 9: JP-A No. 2005-130734
Patent Document 10: JP-A No. 2007-117006
Patent Document 11: Japanese Patent No. 3590051
Patent Document 12: Japanese Patent No. 4136922
Patent Document 13: Japanese Patent No. 4015631

### DISCLOSURE OF THE INVENTION

### Problems to be Solved by the Invention

Along with popularization of a green tea beverage, particularly, a green tea beverage packed in a container, consumer taste and drinking situations have also become diversified and a green tea beverage packed in a container that has unique taste and characteristic odor is demanded.

In a green tea beverage, if the richness and the concentration feeling are rendered strong, the odor note becomes weaker relatively, and the odor is suppressed particularly in drinking in a cold state. In addition, a green tea beverage contains water-insoluble solid contents such as a polysaccharide and a protein, and extraction residues, and appears turbid from these components when the green tea beverage is filled into a transparent container, resulting in an undesirable appearance although it has no problem in quality. Filtration of the green tea beverage to remove them allows a beverage that is transparent. However, by such filtration, the concentration feeling may be suppressed and become plain taste. Particularly, when a green tea beverage is drunk in a state stored for a long period, or in a cold state, the flavor becomes weaker, and is sensed further plainer.

To resolve such problems, the present invention provides a new green tea beverage packed in a container, which has a good balance of taste and odor, and has refreshing aftertaste with nutritious taste, and has odor note and nutritious taste even in a cold state.

### Means for Solving the Problems

The green tea beverage packed in a container of the present invention has the concentration of sugars that are the sum of reducing sugars and non-reducing sugars, being ppm to 250 ppm, the ratio of the non-reducing sugar concentration relatively to the reducing sugar concentration (non-reducing sugar/reducing sugar) being 2.0 to 8.0, and the particle size of the cumulative 90% by mass (D90) being 2500 μm or more.

The green tea beverage packed in a container of the present invention makes it possible to obtain a new green tea beverage packed in a container that has a good balance of taste and odor, and has refreshing aftertaste with nutritious taste, and has odor note and nutritious taste even in a cold state, by adjustment of the concentration of sugars that are the sum of reducing sugars and non-reducing sugars, the concentration ratio of the non-reducing sugar to the reducing sugar and the cumulative mass fraction of 90% (D90).

### MODE FOR CARRYING OUT THE INVENTION

Hereinafter, one exemplary embodiment of the green tea beverage packed in a container of the present invention will be explained. However, the present invention is not limited to this exemplary embodiment.

The present green tea beverage packed in a container is a beverage obtained by filling a container with a liquid containing an extraction liquid or an extract that is obtained by extraction of a green tea as a major component. The liquid includes, for example, a liquid that comprises only an extraction liquid that is obtained by extraction of a green tea, or a liquid obtained by dilution of the extraction liquid, or a liquid obtained by mixing of the tea extraction liquids with each other, or a liquid obtained by addition of an additive to any of the above-mentioned liquids, or a liquid obtained by dispersion of those dried of any of the above-mentioned liquids and the like.

The “major component” encompasses a meaning that containing of other components is acceptable within a range of not interrupting the functions of the major component. At this time, the content ratio of the major component is not specified, but an extraction liquid or an extract that is obtained by extraction of a green tea, preferably takes up 50% or more by mass, particularly 70% or more by mass, and particularly 80% or more by mass (including 100%) in the solid content concentration in the beverage.

In addition, the kind of the green tea is not particularly limited. Examples of the kind of the green tea include broadly teas that are classified as a non-fermented tea such as a steamed tea, a decocted tea, a refined green tea, a green powdered tea, a coarse tea, a bead green tea, an oven-roasted tea, and a Chinese green tea, and also encompasses a blend of 2 kinds or more thereof. In addition, cereals such as a brown rice, a flavor such as jasmine, and the like may be also added thereto.

One exemplary embodiment of the green tea beverage packed in a container of the present invention (referred to as “the present green tea beverage packed in a container”) is characterized by having the concentration of sugars that are the sum of reducing sugars and non-reducing sugars, being 75 ppm to 250 ppm, the concentration ratio of the non-reducing sugar to the reducing sugar (non-reducing sugar/reducing sugar) being 2.0 to 8.0, and the particle size of the cumulative 90% by mass (D90) being 2500 μm or more.

The reducing sugar is a sugar that shows reducing character, and forms an aldehyde group and a ketone group in an alkaline solution. The reducing sugar referred to in the present invention is glucose, fructose, cellobiose or maltose.

The non-reducing sugar is a sugar that does not show reducing character, and the non-reducing sugar referred to in the present invention represents sucrose, stachyose or raffinose.

The concentration of sugars that are the sum of reducing sugars and non-reducing sugars (hereinafter, referred to as the sugar concentration.), being 75 ppm to 250 ppm, allows a beverage that has a balance of the taste and the odor being maintained, and has sweet taste and richness, and has small bitter astringent taste and coarse taste, etc. as the aftertaste even in drinking in a state stored for a long period at normal temperature, or in a cold state.

From such viewpoint, the sugar concentration is preferably 90 ppm to 120 ppm.

The adjustment of the sugar concentration to the above-described range is achieved by adjustment of dry (firing) process or extraction of the tea leaves to suitable conditions. For example, if the dry (firing) process of the tea leaves is performed strongly, the sugars are decomposed and decrease. In addition, if extraction of the tea leaves is performed at a temperature for a long time, the sugars are decomposed and decrease. Therefore, the sugar concentration may be adjusted by the dry (firing) conditions or the extraction conditions of the tea leaves.

At this time, although the adjustment may be performed by addition of sugars, this has a fear of collapsing the balance of a green tea beverage, so the adjustment is preferably achieved not by addition of sugars, but by adjustment of conditions for obtaining a tea extraction liquid, and in addition, by mixing of the tea extraction liquids with each other, or by addition of a tea extract, or the like.

In addition, when the ratio of the non-reducing sugar concentration relatively to the reducing sugar concentration (non-reducing sugar/reducing sugar) is 2.0 to 8.0, it allows sweet taste of fire odor and proper concentration feeling when the green tea beverage is put into the mouth.

From such viewpoint, the ratio of the non-reducing sugar concentration relatively to the reducing sugar concentration (non-reducing sugar/reducing sugar) is preferably 2.5 to 7.2, and particularly preferably 2.9 to 7.0.

In adjustment of the ratio of the non-reducing sugar concentration relatively to the reducing sugar concentration to the above-described range, dry (firing) process or extraction of the tea leaves may be adjusted to suitable conditions. For example, if the dry (firing) process is performed on tea leaves, reducing sugars decrease first, and then non-reducing sugars decrease. Therefore, with dry (firing) process to for tea leaves and extraction at low temperature for a long time, the ratio of the non-reducing sugar/reducing sugar can be lowered.

At this time, although the adjustment may be performed by addition of sugars, this has a fear of collapsing the balance of a green tea beverage, so the adjustment is preferably performed not by addition sugars, but by adjustment of conditions to obtain a tea extraction liquid, and in addition, by mixing of the tea extraction liquids with each other, or by addition of a tea extract, or the like.

The concentration of total catechins in the present green tea beverage packed in a container is preferably 350 ppm to 920 ppm.

The concentration of the total catechins is more preferably 350 ppm to 850 ppm, and particularly further preferably 400 ppm to 850 ppm.

At this time, the total catechins mean total 8 kinds of catechin (C), gallocatechin (GC), catechin gallate (Cg), gallocatechin gallate (GCg), epicatechin (EC), epigallocatechin (EGC), epicatechin gallate (ECg) and epigallocatechin gallate (EGCg), and the concentration of the total catechins means the value of a total of the concentrations of the 8 kind catechins.

In adjustment of the concentration of the total catechins to the above-described range, the concentration of the total catechins may be adjusted by extraction conditions. At this time, although the adjustment may be performed by addition of catechins, this has a fear of collapsing the balance of a green tea beverage, so the adjustment is preferably performed by adjustment conditions for obtaining a tea extraction liquid, and addition, by mixing of the tea extraction liquids with each other, or by addition of a tea extract, or the like.

The concentration of the electron-localized catechins in the present green tea beverage packed in a container is preferably 260 ppm to 810 ppm.

The concentration of the electron-localized catechins is particularly preferably 305 ppm to 750 ppm.

The “electron-localized catechin” referred to in the present invention is a catechin that has a triol structure (a structure having 30H groups adjacent to the benzene ring), and is considered to be likely to have localization of the electric charge when ionized. Specifically, examples of the “electron-localized catechin” include epigallocatechin gallate (EGCg), epigallocatechin (EGC), epicatechin gallate (ECg), gallocatechin gallate (GCg), gallocatechin (GC), and catechin gallate (Cg).

In adjustment of the concentration of the electron-localized catechins to the above-described range, the concentration of the electron-localized catechins may be adjusted with the extraction conditions. However, the concentration of the electron-localized catechin easily changes with the extraction time and the temperature, and thus if the temperature is too high, or the extraction time is too long, it is not preferable also in view of maintaining the aroma of the beverage. At this time, although the adjustment may be performed by addition of the electron-localized catechin, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

The ratio of the concentration of electron-localized catechins relatively to the sugar concentration (electron-localized catechin/sugars) in the present green tea beverage packed in a container is preferably 3.5 to 7.5. If the ratio is within this range, the present green tea beverage packed in a container becomes a beverage that has a balance of the astringent taste and the sweet taste being maintained, has the richness and the concentration feeling in the taste, and has deep delicious taste.

The ratio of the concentration of electron-localized catechins relatively to the sugar concentration (electron-localized catechin/sugars) is more preferably 3.6 to 6.8.

In adjustment of the ratio of the concentration of electron-localized catechins relatively to the sugar concentration to the above-described range, the ratio may be adjusted with the extraction conditions. However, although the extraction rate of catechin increases at a high temperature, sugars are likely decompose and thus the extraction time preferably short. At this time, although the adjustment may be performed by addition of the electron-localized catechin and the sugars, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

In the present green tea beverage packed in a container, the ratio of the sugar concentration relatively to the theanine concentration (sugars/theanine) is preferably 5 to 25.

The theanine is a derivative of glutamic acid contained in a green tea or the like, and examples thereof include L- or D-glutamic acid-γ-alkyl amide such as L-glutamic acid-γ-ethyl amide (L-theanine), L-glutamic acid-γ-methyl amide, D-glutamic acid-γ-ethyl amide (D-theanine), and D-glutamic acid-γ-methyl amide, and a derivative containing the L- or D-glutamic acid-γ-alkyl amide in the basic structure (for example, glycoside of L- or D-glutamic acid-γ-alkyl amide and the like), or the like.

In adjustment of the ratio of the sugar concentration relatively to the theanine concentration to the above-described range, the ratio may be adjusted with strong dry conditions for raw materials. At this time, although the adjustment may be performed by addition of sugars and theanine, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of the soluble solid content derived from the tea leaves in the present green tea beverage packed in a container is preferably 0.23% to 0.50%. The soluble solid content derived from the tea leaves is a sucrose-converted value of the soluble solid content obtained by extraction of the green tea.

The soluble solid content derived from the tea leaves in the present green tea beverage packed in a container is more preferably 0.25% to 0.42%, and particularly further preferably 0.30% to 0.40%.

In adjustment of the soluble solid content derived from the tea leaves to the above-described range, the soluble solid content may be suitably adjusted with adjustment of the amount of the tea leaves and the extraction conditions.

In the present green tea beverage packed in a container, the ratio of the sugar concentration relatively to the concentration of the soluble solid content derived from the tea leaves (sugars/(soluble solid content derived from the tea leaves×100)) is preferably 2.5 to 5.0. If such ratio is within this range, it allows a beverage that has properly richness and the concentration feeling of the taste to astringent taste and the like, and has a balance of the odor and the taste, and has deep taste.

From such viewpoint, the ratio of the sugar concentration relatively to the concentration of the soluble solid content derived from the tea leaves is more preferably 2.6 to 4.4, and particularly further preferably 2.8 to 4.0.

In adjustment of the ratio of the sugar concentration relatively to the concentration of the soluble solid content derived from the tea leaves to the above-described range, the ratio may be adjusted by increasing the tea leaf amount whereby to elevate the concentration of the soluble solid content, and by combination with the drying conditions for the raw tea leaves. At this time, although the adjustment may be performed by addition of the sugars, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

In the present green tea beverage packed in a container, the ratio of the concentration of electron-localized catechins relatively to the concentration of the soluble solid content derived from the tea leaves (electron-localized catechin/(soluble solid content derived from the tea leaves×100)) is preferably 15.0 to 20.0. When such ratio is within this range, the present green tea beverage packed in a container becomes a beverage that appropriately has the concentration feeling by the astringent taste to the sweet taste or the like, and has a balance of odor afterglow and the concentration feeling of the taste, and further is also stable in the aspect with age.

From such viewpoint, the ratio of the concentration of electron-localized catechins relatively to the concentration of the soluble solid content derived from the tea leaves is more preferably 15.0 to 19.5.

In adjustment of the ratio of the concentration of electron-localized catechins relatively to the concentration of the soluble solid content derived from the tea leaves, to the above-described range, the adjustment may be performed with extraction conditions or the like since the dissolution properties of catechins at the extraction temperature are different to each other. At this time, although the adjustment may be performed by addition of the sugars, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

In the present green tea beverage packed in a container, the ratio of the total catechin concentration relatively to the concentration of the soluble solid content derived from the tea leaves (total catechin/(soluble solid content derived from the tea leaves×100)) is preferably 16.8 to 22.7.

The ratio of the total catechin concentration relatively to the concentration of the soluble solid content derived from the tea leaves is more preferably 17.0 to 22.0, and particularly further preferably 18.0 to 21.6.

In adjustment of the ratio of the total catechin concentration relatively to the concentration of the soluble solid content derived from the tea leaves, to the above-described range, the adjustment may be performed with the dry conditions and the extraction conditions of the tea leaves.

At this time, although the adjustment may be performed by addition of the catechins, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

In the present green tea beverage packed in a container, the content ratio of furfural relatively to geraniol (furfural/geraniol) is preferably 0.5 to 3.0. When the content ratio is within this range, the present green tea beverage packed in a container becomes a beverage that has a balance of spreading and afterglow of fire odor, and greenish afterglow of deep odor when the green tea beverage is put into the mouth, and has odor of deep taste.

From such viewpoint, the content ratio of furfural relatively to geraniol (furfural/geraniol) is particularly preferably 0.6 to 2.9, and further preferably 0.8 to 2.6.

In adjustment of the content ratio of furfural relatively to geraniol to the above-described range, the adjustment may be performed by suitably adjusting the conditions for the dry (firing) process or extraction of the tea leaves. For example, if the dry (firing) process is performed at a low temperature on the tea leaves, the content ratio can be decreased, and if the dry (firing) process is performed at a high temperature on the tea leaves, the content ratio can be increased.

At this time, although the adjustment may be performed by addition of aroma chemicals or the like containing furfural and geraniol, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

By the fact that the particle size of the cumulative 90% by mass (D90) is 2500 μm or more in the present green tea beverage packed in a container, it is possible to prepare a beverage that has few fine particles and excellent odor note and is transparent.

From such viewpoint, the particle size of the cumulative 90% by mass (D90) is preferably 2700 μm or more.

In adjustment of the particle size of the cumulative 90% by mass (D90) to the above-described range, D90 may be adjusted by performing a dry (firing) process for raw materials, or by filtration of the extraction liquid, or the like. Examples of the filtration include ultrafiltration, fine filtration, precise filtration, inverse osmotic membrane filtration, electrodialysis, filtration by a membrane such as a biofunctional membrane, and in addition, and filter cake filtration using a porous media. Among them, adjustment by filter cake filtration using either one or both of a filter media largely containing silica content, and a porous media such as kieselguhr, is preferable from the viewpoints of productivity and adjustment of the particle size.

In the present green tea beverage packed in a container, the particle size (D10) of the cumulative 10% by mass is preferably 350 μm or more. This range makes it possible to prepare a beverage that has little coarse taste and is transparent.

From such viewpoint, the particle size (D10) of the cumulative 10% by mass is more preferably 400 μm or more, and particularly preferably 1000 μm or more.

In adjustment of the particle size (D10) of the cumulative 10% by mass to the above-described range, D10 may be adjusted by performing a dry (firing) process or filtration of the extraction liquid, or the like. Examples of the filtration include ultrafiltration, fine filtration, precise filtration, inverse osmotic membrane filtration, electrodialysis, filtration by a membrane such as a biofunctional membrane, and in addition, and filter cake filtration using a porous media. Among them, adjustment by filter cake filtration using either one or both of a filter media largely containing silica content, and a porous media such as kieselguhr, is preferable from the viewpoints of productivity and adjustment of the particle size.

The particle sizes of the above-described D90 and D10 are those measured for the size of particles of water-insoluble solid content such as a polysaccharide and a protein, extraction residue, etc. in the present green tea beverage packed in a container, or the size of particles that are precipitated by adsorption of other components to them as a nucleus.

The pH of the present green tea beverage packed in a container is preferably 6.0 to 6.5 at 20° C. The pH of the present green tea beverage packed in a container is more preferably 6.0 to 6.4, and particularly further preferably 6.1 to 6.3.

The concentrations of the reducing sugar, the non-reducing sugar, the total catechin, the electron-localized catechin and theanine described above can be measured by a calibration curve method and the like using a high performance liquid chromatogram (HPLC) or the like.

In addition, the content ratio of furfural relatively to geraniol can be measured with a solid phase micro-extraction (SPME) method or the like, and the above-described D90 and D10 can be measured by laser diffraction type equipment for measuring particle size distribution or the like.

(Container)

A container to be filled with the present green tea beverage packed in a container is not particularly limited. For example, a plastic-made bottle (so-called PET bottle), a can of metal such as steel and aluminum, a bottle, a paper container and the like may be used, and particularly, a transparent container such as a PET bottle and the like may be preferably used as the container.

(Manufacturing method)

The present green tea beverage packed in a container may be manufactured by, for example, selecting raw materials for tea leaves, and suitably adjusting conditions for a dry (firing) process and extraction for the tea leaves, whereby to adjust the sugar concentration, which is the sum of the reducing sugar concentration and the non-reducing sugar concentration in the beverage, to 75 ppm to 250 ppm, to adjust the ratio of the non-reducing sugar concentration relatively to the reducing sugar concentration (non-reducing sugar/reducing sugar), to 2.0 to 8.0, and to adjust the particle size of the cumulative 90% by mass (D90) to 2500 μm or more.

For example, the present green tea beverage packed in a container can be manufactured by preparing an extraction liquid, which is obtained by subjecting tea leaves to a dry (firing) process at 200° C. to 270° C. and subjecting the tea leaves to extraction at a high temperature for a short time, and a conventional general green tea extraction liquid, i.e., an extraction liquid that is obtained by subjecting tea leaves to a dry (firing) process at 80° C. to 150° C. and subjecting the tea leaves to extraction at a low temperature for a long time; filtering; and then blending them in a suitable ratio.

With regard to the dry process, the dry process is preferably the “firing” referred to in the tea processing, i.e., a step of picking out the unique odor of a green tea. For example, the dry process is preferably dry hot wind, direct firing, far infrared ray or the like, which is used alone or in combination of plurals in a type such as the shelf type and the drum type in view of fire odor and sweet odor. However, the invention is not limited to such manufacturing method.

As described above, by performing the dry (firing) process on tea leaves, the reducing sugars decrease first and then the non-reducing sugars decrease. Accordingly, by adjustment of the conditions for the dry (firing) process, the sugar concentration and the value of the non-reducing sugar/reducing sugar may be adjusted.

In addition, in adjustment of the particle size, the dry (firing) process on tea leaves may be performed, but filter cake filtration using either one or both of a filter media largely containing silica content and a porous media such as kieselguhr, is preferably performed for the extraction liquid.

(Kieselguhr Filtration)

In one example of the kieselguhr filtration, an auxiliary layer (pre-coat) formed from kieselguhr is formed onto a filtration carrier surface, and a neat liquid (tea extraction liquid as an unfiltered liquid) is sent to the above-mentioned auxiliary layer while a kieselguhr filtering agent is injected (body feed) to the neat liquid extraction liquid as an unfiltered liquid) as necessary.

Herein, the “pre-coat” is an auxiliary layer in several mm thickness formed on the surface of a filtration carrier (for example, metal-made net (leaf), thick filter paper (filter pad), laminated metal ring (candle), ceramic tube (candle) and the like) by dispersing an auxiliary agent in a clear liquid and circulating the resulting liquid before filtration manipulation, which makes it possible to prevent contamination by direct attachment of the suspending solid content to the filtering medium, and improve the clarification degree of the filtrate.

As the kieselguhr used in the present invention, kieselguhr that is used as a filtration aid may be used, such as those obtained by trituration and dry treatment of a raw ore of kieselguhr, those obtained by further burning or fusing agent-burning treatment to those obtained by the trituration and dry treatment, and the like. However, a kieselguhr filtration aid having 0.05 to 0.2 Darcy may be preferably used. By using the kieselguhr filtration aid having 0.05 to 0.2 Darcy, it is possible to manufacture a clearer tea beverage packed in a container. The “kieselguhr filtration aid having 0.05 to 0.2 Darcy” means a kieselguhr filtration aid of which the Darcy permeability K is within a range of 0.05 to 0.2. The “Darcy permeability K” is one of the indexes that represent permeability of a filtration aid, and may be calculated by a water permeation method or an air permeation method. At the moment, the “Darcy” is so generally used as wide as that a kieselguhr filtration aid having designated Darcy value may be purchased.

In addition, as the kieselguhr used in the present invention, a kieselguhr from which iron is eluted and removed by acid treatment is preferably used. This is because the iron has an influence on the taste in the green tea beverage, and also becomes a cause for browning. A method of the acid treatment for kieselguhr is not particularly limited. For example, methods may be adopted such as a method in which kieselguhr and acidic water are added to a mixing bath and then agitated, a method in which acid is added to a mixture of kieselguhr and water in a mixing bath and then agitated, and a method in which kieselguhr and acidic water are brought into contact with each other by any method, and then solid-liquid isolated, and then washed with water to use kieselguhr in an aqueous suspension state or wet state as it is. By using the kieselguhr in an aqueous suspension state or wet state as it is, the iron content eluted from kieselguhr can be further lowered. Herein, the acidic water represents acidic water (acidic aqueous solution) having less than 7.0 pH, preferably 1 to 5 pH, and examples thereof include an aqueous solution of an organic acid such as citric acid, lactic acid, and acetic acid, and an inorganic acid such as phosphoric acid, nitric, acid and hydrochloric acid.

Other filtration aids such as silica gel, pearlite and cellulose may be mixed and used with the kieselguhr.

(Silica Adsorption)

With regard to the silica adsorption, silica is added to a tea extraction liquid to bring the tea extraction liquid into contact with silica, whereby to cause sediment components in the tea extraction liquid to be selectively absorbed onto silica and the added silica may be removed in a later step.

As the silica to be added, silica (silicon dioxide; SiO₂), and in addition, a silica-containing material that contains silica as a major component (taking up 50% or more of the total mass) may be used.

The silica (silicon dioxide; SiO₂) may be either crystalline or non-crystalline. In addition, the silica may be a natural product or a synthetic product. When the silica is a synthetic product, silica that is manufactured by any synthetic method such a dry method (gas phase method), a wet method (water glass method including a gel type and a precipitation type), and a sol-gel method, may be used.

Examples of the silica-containing material include silicate, clay mineral such as kieselguhr, crystal, and quartz which are natural products.

By addition of silica to the tea extraction liquid to bring the tea extraction liquid into contact with silica, it is possible to cause sediment components contained in the tea extraction liquid, particularly partial protein and polysaccharide that form a secondary sediment to be absorbed onto silica, whereby to reduce the concentration of the sediment components in the tea extraction liquid.

The addition amount of silica is preferably 0.5 to 20 times, particularly 1 to 10 times the amount of the raw materials for extraction of the green tea (mass of tea leaves).

It is possible to adjust adsorption performance of silica by controlling the addition amount, and in addition, the particle size, the pore size, and electric charge of silica, and hydroxy groups existing on the silica surface (silanol group), whereby to adjust the kind and the amount of the protein and the polysaccharide that are adsorbed and removed, whereby to adjust the flavor of the green tea beverage.

Regarding specific adsorption method, for example, silica may be added to a tea extraction liquid and then agitated, or silica may be added to a tea extraction liquid after coarse filtration and the tea extraction liquid with silica is sent to the next step whereby to bring the tea extraction liquid into contact with silica in the liquid-sending process. In addition, silica may be added several times as divided to be dispersed for adsorption.

At this time, it is preferable that after the addition of silica to the tea extraction liquid, the tea extraction liquid is in contact with silica while being cooled to 20 to 40° C. If the tea extraction liquid is cooled to 20° C. or less, there is a fear that cream down occurs to reduce adsorption performance of silica. On the other hand, if the temperature is higher than 40° C., the tea extraction liquid may change due to the heat, thereby impairing the flavor.

In addition, the tea extraction liquid to be added with silica is preferably adjusted to be in a weak acidic region (pH 4.5 to 5.5). Adjustment to the weak acidic region suppresses change of catechins. It should be noted that if the pH is lower than 4.5, there is a fear that cream down occurs to reduce adsorption performance of silica.

In removing silica from the tea extraction liquid, a silica filtration step of removing silica may be added, or silica may be removed in centrifugal isolation, kieselguhr filtration, or other filtration steps following the adsorption step.

(Explanation For Terms)

The “green tea beverage” in the present invention means a beverage containing a tea extraction liquid or tea extract that is obtained from tea extraction, as a major component.

In addition, the “green tea beverage packed in a container” means a green tea beverage that is packed in a container, and also means a green tea beverage that may be provided for drinking without dilution.

When “X to Y” (X and Y are any numbers) is expressed in the present specification, it encompasses the meaning of “X or more and Y or less”, and also the meaning of “preferably greater than X” and “preferably less than Y” unless otherwise stated.

### EXAMPLES

Hereinafter, Examples of the present invention will be explained. However, the present invention is not limited to this Example.

The “reducing sugar concentration” in Examples means a total concentration of glucose, fructose, cellobiose and maltose, and the “non-reducing sugar concentration” means a total concentration of sucrose, stachyose and raffinose.

<Evaluation Test 1>

Extraction Liquids A to D described below were prepared, and using these Extraction Liquids, green tea beverages of Examples 1 to 4 and Comparative Examples 1 to were prepared, and sensory evaluations therefor were performed.

(Extraction Liquid A)

Tea leaves (Yabukita species, first flush tea produced in Kagoshima Prefecture) after plucking were subjected to Aracha process, and to a dry process (firing process) with a rotation drum type firing machine under the conditions of 85° C. of the setting temperature and 25 minutes of the dry time. The tea leaves were extracted under the conditions of 90 g of the tea leaves, 10 L of 60° C. hot water, and 7 minutes of the extraction time. This extraction liquid was filtered with a stainless mesh (20 mesh) to remove the tea grounds, and then further filtered with a stainless mesh (80 mesh), to obtain Extraction Liquid A.

(Extraction Liquid B)

Tea leaves (Yabukita species, first flush tea produced in Kagoshima Prefecture) after plucking were subjected to Aracha process, and to a dry process (firing process) with a rotation drum type firing machine under the conditions of 145° C. of the setting temperature and 20 minutes of the dry time. The tea leaves were extracted under the conditions of 80 g of the tea leaves, 10 L of 85° C. hot water, and 5.5 minutes of the extraction time. This extraction liquid was filtered with a stainless mesh (20 mesh) to remove the tea grounds, and then further filtered with a stainless mesh (80 mesh), to obtain Extraction Liquid B.

(Extraction Liquid C)

Tea leaves (Yabukita species, third flush tea produced in Miyazaki Prefecture) after plucking were subjected to Aracha process with an oven-roasting method, and to a dry process (firing process) with a rotation drum type firing machine under the conditions of 265° C. of the setting temperature and 15 minutes of the dry time. The tea leaves were extracted under the conditions of 55 g of the tea leaves, 10 L of 90° C. hot water, and 5.5 minutes of the extraction time. This extraction liquid was filtered with a stainless mesh (20 mesh) to remove the tea grounds, and then further filtered with a stainless mesh (80 mesh), to obtain Extraction Liquid C.

(Extraction Liquid D)

Tea leaves (Yabukita species, third flush tea produced in Miyazaki Prefecture) after plucking were subjected to Aracha process with an oven-roasting method, and to a dry process (firing process) with a rotation drum type firing machine under the conditions of 200° C. of the setting temperature and 15 minutes of the dry time. The tea leaves were extracted under the conditions of 100 g of the tea leaves, 10 L of 85° C. hot water, and 3.5 minutes of the extraction time. This extraction liquid was filtered with a stainless mesh (20 mesh) to remove the tea grounds, and then further filtered with a stainless mesh (80 mesh), to obtain Extraction Liquid D.

(Filtration)

Each of the Extraction Liquids A to D was divided into two containers, either one was Nell-filtered with use of a Nell fabric to prepare Extraction Liquids A1 to D1, and the other one was Nell-filtered with use of Nell fabric, and then further kieselguhr-filtered with body-feeding 0.2% by mass of kieselguhr (“P5” manufactured by Showa Chemical Industry Co., Ltd.) relatively to the liquid amount onto a filter plate in which 2 mm thick pre-coat was formed on a filtration carrier (FILTER PAD manufactured by Advantec MFS) with use of 700 g of the kieselguhr per 1 to prepare Extraction Liquids A2 to D2.

(Measurement For Particle Size)

1/10 amount of each extraction liquid described above was weighed, added with ascorbic acid in 400 ppm, and then added with sodium bicarbonate to adjust pH to 6.2, and added with ion-exchanged water to adjust the total amount to 500 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C. For the solution, the particle size of the cumulative 90% by mass (D90) and the particle size of the cumulative 10% by mass (D10) were measured using laser diffraction equipment for measuring particle size distribution (“SALD-2100” manufactured by Shimadzu Corporation). The results of the measurements are shown in Table 1 described below.

TABLE 1

| | D10 | D90 |
|---|---|---|
| A1 | 2.8 | 25.0 |
| A2 | 1257.8 | 79501 |
| B1 | 2.7 | 24.9 |
| B2 | 1257.1 | 7949.5 |
| C1 | 2.8 | 25.3 |
| C2 | 1267.9 | 7956.8 |
| D1 | 2.6 | 24.8 |
| D2 | 1262.6 | 7954.7 |

(Blending)

Extraction Liquids A1 to D1 and A2 to D2 were blended in the ratios shown in Table 2 described below. In addition, extract containing geraniol and furfural was appropriately added, and added with ascorbic acid in 400 ppm, and then added with sodium bicarbonate to adjust pH to 6.2, and added with ion-exchanged water to adjust the total amount to 5000 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C., to prepare the green tea beverages of Examples 1 to 4 and Comparative Examples 1 to 7.

TABLE 2

| | A1 | A2 | B1 | B2 | C1 | C2 | D1 | D2 | Total |
|---|---|---|---|---|---|---|---|---|---|
| Example 1 | 45 | 30 | 0 | 0 | 20 | 5 | 0 | 0 | 100 |
| Comparative | 75 | 0 | 0 | 0 | 5 | 20 | 0 | 0 | 100 |
| Example 1 | | | | | | | | | |
| Example 2 | 0 | 0 | 0 | 0 | 20 | 25 | 0 | 55 | 100 |
| Comparative | 0 | 0 | 0 | 0 | 40 | 5 | 35 | 20 | 100 |
| Example 2 | | | | | | | | | |
| Example 3 | 5 | 0 | 0 | 65 | 5 | 0 | 25 | 0 | 100 |
| Example 4 | 0 | 5 | 0 | 0 | 0 | 0 | 25 | 70 | 100 |
| Comparative | 100 | 0 | 0 | 0 | 0 | 0 | 0 | 0 | 100 |
| Example 3 | | | | | | | | | |
| Comparative | 0 | 100 | 0 | 0 | 0 | 0 | 0 | 0 | 100 |
| Example 4 | | | | | | | | | |
| Comparative | 0 | 0 | 60 | 40 | 0 | 0 | 0 | 0 | 100 |
| Example 5 | | | | | | | | | |
| Comparative | 0 | 0 | 0 | 0 | 100 | 0 | 0 | 0 | 100 |
| Example 6 | | | | | | | | | |
| Comparative | 0 | 0 | 0 | 0 | 50 | 50 | 0 | 0 | 100 |
| Example 7 | | | | | | | | | |

(Analysis)

Components and pH of the green tea beverages of Examples 1 to 4 and Comparative Examples 1 to 7 were measured as shown below. The results are shown in Table 3 described below.

TABLE 3

| | | | Compar- | | Compar- | | | Compar- | Compar- | Compar- | Compar- | Compar- |
|---|---|---|---|---|---|---|---|---|---|---|---|---|
| | | Exam- | ative | | ative | | | ative | ative | ative | ative | ative |
| | | ple 1 | Example 1 | Example 2 | Example 2 | Example 3 | Example 4 | Example 3 | Example 4 | Example 5 | Example 6 | Example 7 |
| Sugars | | 114.8 | 114.8 | 96.5 | 96.5 | 82.2 | 113.3 | 127.5 | 127.5 | 67.4 | 76.8 | 76.8 |
| Non-Reducing | | 3.79 | 3.79 | 5.79 | 5.79 | 7.19 | 2.77 | 1.91 | 1.91 | 9.11 | 9.42 | 9.42 |
| Sugar/Reducing | | | | | | | | | | | | |
| Sugar | | | | | | | | | | | | |
| Electron-Localized | | 3.62 | 3.62 | 5.61 | 5.61 | 7.12 | 6.71 | 3.47 | 3.47 | 7.73 | 4.07 | 4.07 |
| Catechin/Sugars | | | | | | | | | | | | |
| Electron-Localized | | 409.7 | 409.7 | 566.3 | 566.3 | 569.9 | 757.6 | 442.1 | 442.1 | 521.0 | 312.3 | 312.3 |
| Catechin (ppm) | | | | | | | | | | | | |
| Furfural/Geraniol | | 1.38 | 1.39 | 2.35 | 2.35 | 2.96 | 0.77 | 0.42 | 0.43 | 3.89 | 4.26 | 4.25 |
| pH | | 6.2 | 6.2 | 6.2 | 6.2 | 6.2 | 6.2 | 6.2 | 6.2 | 6.2 | 6.2 | 6.2 |
| Electron-Localized | | 15.12 | 15.12 | 17.32 | 17.32 | 17.72 | 18.67 | 15.40 | 15.40 | 17.54 | 14.00 | 14.00 |
| Catechin/(Soluble | | | | | | | | | | | | |
| Solid Content | | | | | | | | | | | | |
| Derived From Tea | | | | | | | | | | | | |
| Leaves × 100) | | | | | | | | | | | | |
| Total Catechin | | 458.2 | 458.2 | 637.3 | 637.3 | 641.0 | 854.7 | 494.7 | 494.7 | 585.3 | 348.5 | 348.5 |
| (ppm) | | | | | | | | | | | | |
| Soluble Solid | | 0.27 | 0.27 | 0.33 | 0.33 | 0.32 | 0.41 | 0.29 | 0.29 | 0.30 | 0.22 | 0.22 |
| Content Derived | | | | | | | | | | | | |
| From Tea Leaves | | | | | | | | | | | | |
| (%) | | | | | | | | | | | | |
| Brix | | 0.32 | 0.32 | 0.39 | 0.39 | 0.37 | 0.46 | 0.33 | 0.33 | 0.34 | 0.28 | 0.28 |
| Total | | 16.91 | 16.91 | 19.49 | 19.49 | 19.93 | 21.06 | 17.24 | 17.24 | 19.71 | 15.63 | 15.63 |
| Catechin/(Soluble | | | | | | | | | | | | |
| Solid Content | | | | | | | | | | | | |
| Derived From Tea | | | | | | | | | | | | |
| Leaves × 100) | | | | | | | | | | | | |
| Sugars/(Soluble | | 4.24 | 4.24 | 2.95 | 2.95 | 2.56 | 2.79 | 4.44 | 4.44 | 2.27 | 3.44 | 3.44 |
| Solid Content | | | | | | | | | | | | |
| Derived From Tea | | | | | | | | | | | | |
| Leaves × 100) | | | | | | | | | | | | |
| D10 | | 442.47 | 255.67 | 1011.97 | 317.95 | 818.04 | 947.36 | 2.60 | 1257.80 | 504.46 | 2.80 | 635.35 |
| D90 | | 2799.21 | 1611.38 | 6369.35 | 2007.58 | 5175.89 | 5972.00 | 25.00 | 7950.20 | 3194.74 | 25.30 | 3991.05 |
| Initial Odor | | ◯ | Δ | ⊚ | Δ | ⊚ | ◯ | X | X | ◯ | Δ | ◯ |
| Middle Odor | | ⊚ | Δ | ◯ | Δ | ◯ | ⊚ | ⊚ | Δ | X | Δ | Δ |
| Odor remaining in | | ◯ | Δ | ⊚ | Δ | ◯ | ◯ | X | Δ | X | X | Δ |
| the mouth | | | | | | | | | | | | |
| Nutritious taste | | ◯ | Δ | ⊚ | ◯ | ◯ | ⊚ | Δ | Δ | Δ | Δ | Δ |
| With | Secondary | ± | + | − | + | ± | ± | + | ± | ± | + | ± |
| age | sediment | | | | | | | | | | | |
| | Color | ◯ | Δ | ⊚ | Δ | ◯ | ◯ | X | Δ | Δ | X | Δ |
| | Change | | | | | | | | | | | |
| Total | Internal | ⊚ | Δ | ⊚ | Δ | ◯ | ⊚ | X | X | X | Δ | Δ |
| | Quality | | | | | | | | | | | |
| | Appearance | ◯ | X | ⊚ | X | ◯ | ◯ | X | X | X | X | X |

| | | | | | | | | | | | |
|---|---|---|---|---|---|---|---|---|---|---|---|
| Total Evaluation | ◯ | X | ⊚ | X | ◯ | ◯ | X | X | X | X | X |

The reducing sugar concentration and the non-reducing sugar concentration were quantity-measured by a calibration curve method with manipulation of HPLC sugar analysis equipment (manufactured by Dionex Corporation) under the conditions described below.

Column: “Carbopack PA1 φ4.6×250 mm” manufactured by Dionex Corporation

Column Temperature: 30° C.

Mobile Phase:

| | |
|---|---|
| Phase A | 200 mM NaOH |
| Phase B | 1000 mM Sodium Acetate |
| Phase C | Ultrapure water |

Flow Rate: 1.0 mL/min

Injection Amount: 50 μL

Detection: “ED50 gold electrode” manufactured by Dionex Corporation

The electron-localized catechin concentration and the total catechin concentration were quantity-measured by a calibration curve method with manipulation of a high performance liquid chromatogram (HPLC) under the conditions described below.

Column: “Xbridge shield RP18 φ3.5×150 mm” manufactured by Waters Corporation

Column Temperature: 40° C.

Mobile Phase:

| | |
|---|---|
| Phase A | Water |
| Phase B | Acetonitrile |
| Phase C | 1% phosphoric acid |

Flow Rate: 0.5 mL/min

Injection Amount: 5 μL

Detection: “UV230 nm UV detector” manufactured by Waters Corporation

10 mL of the sample, 3 g of NaCl, and 5 μL of 0.1% cyclohexanol as an internal index were added to a vial container, and the vial container was sealed, and then warmed to 60° C. and extracted with a solid phase micro-extraction method (SOME) method for 30 minutes, and the values of geraniol and furfural were measured using the equipment described below.

From the MS spectrum obtained, the characteristic peaks were selected and the content ratio of furfural relatively to geraniol was calculated from the area value.

SPME fiber: “DVB/carboxen/PDMS” manufactured by Supelco

GC-MS System

Equipment: 5973N manufactured by Agilent

Column: “DB-WAX, 60 m×0.25 mm×0.25 μm” manufactured by Agilent

Column oven: 35 to 240° C., 6° C./min

The pH was measured with “F-24,” a pH meter manufactured by HORIBA, Ltd. according to an ordinary method.

The concentration of the soluble solid content (Brix) was measured with “DD-7” manufactured by ATAGO CO., LTD.

(Evaluation Item)

Using the green tea beverages of Examples 1 to 4 and Comparative Examples 1 to 7, the initial odor, the middle odor, the odor remaining in the mouth, the nutritious taste, and the changes with age (secondary sediment and color) were evaluated.

(Evaluation Test)

The green tea beverages of Examples 1 to 4 and Comparative Examples 1 to 7 were kept at an ordinary temperature for one week, and cooled to 5° C. The green tea beverages were tasted by 20 persons of general consumers drinking green teas at ordinary times, and given scores by the evaluations described below. The evaluations were performed wherein “⊚” indicates 3.5 or more, “∘” indicates 3 or more and less than 3.5, “Δ” indicates 2 or more and less than 3, and “x” indicates 1 or more and less than 2 of the average points of the 20 persons. In addition, with regard to the changes with age (secondary sediment and color), the green tea beverages of Examples 1 to 4 and Comparative Examples 1 to 7 were kept at 25° C. for 4 months, and the changes with age were evaluated visually by the examiners described above. The results thereof are shown in Table 3 described above.

<Initial Odor>

Particularly Strong=4

Strong=3

Present=2

Weak=1

<Middle Odor>

Particularly Strong=4

Strong=3

Present=2

Weak=1

<Odor Remaining in the Mouth>

Particularly Strong=4

Strong=3

Present=2

Weak=1

<Nutritious Taste>

Particularly Good=4

Good=3

Usual=2

Weak=1

<Secondary Sediment>

−: None=4

±: Sediment Found When Closely (10 cm or so of distance) Viewed=2

+: “Rice-Grain Sized” Sediment Found In The Bottom Part Of The Container When Distally (50 cm or so of distance) Viewed=0

<Color Change>

Small Change=4

Somewhat Changing=3

Changing=2

Significant Change=1

(Total (Internal Quality and Appearance))

As the total (internal quality), the average points of the initial odor, the middle odor, the odor remaining in the mouth and the nutritious taste were calculated, and the evaluations were performed wherein “⊚” indicates 3.5 or more, “∘” indicates 3 or more and less than 3.5, “Δ” indicates 2 or more and less than 3, and “x” indicates 1 or more and less than 2 of the average point.

As the total (appearance), the average points of the secondary sediment and the color change were calculated, and the evaluations were performed wherein “⊚” indicates 3.5 or more, “∘” indicates 3 or more and less than 3.5, “Δ” indicates 2 or more and less than 3, and “x” indicates 1 or more and less than 2 of the average point.

(Total Evaluation)

As the total evaluations, the average points of the total (internal quality) and the total (appearance) were calculated, and the evaluations were performed wherein “∘” indicates 3.5 or more, “∘” indicates 3 or more and less than 3.5, “Δ” indicates 2 or more and less than 3, and “x” indicates 1 or more and less than 2 of the average point.

For any of Examples 1 to 4, excellent results were obtained, of which the total evaluation was “∘” or better.

On the other hand, for Comparative Examples 1 to 7, the results were not preferable, of which the evaluation was “x.”

From the results of Comparative Examples 1 and 2, it was found that if the particle size of the cumulative 90% by mass (D90) is lowered, the internal quality and also the appearance are poor. From the results of Comparative Examples 3 and 4, it was found that if the value of the non-reducing sugar/reducing sugar is lowered, the whole evaluations become worse. From the results of Comparative Example 5, it was found that if the balance of sugars becomes worse, any of the odors also becomes weak.

From these results, it is assumed that the ranges of the sugar concentration being 75 ppm to 250 ppm, the ratio of the non-reducing sugar concentration relatively to the reducing sugar concentration (non-reducing sugar/reducing sugar) being 2.0 to 8.0, and the particle size of the cumulative 90% by mass (D90) being 2500 μm or more, are ranges that allow the initial odor, the middle odor, the odor remaining in the mouth, the nutritious taste, the secondary sediment and the color change to become better, and it was discovered that a green tea beverage of which these items are in these ranges, has a good balance of taste and odor, and has refreshing aftertaste with nutritious taste, and has odor note and nutritious taste even in a cold state.

<Evaluation Test 2>

Extraction Liquids E and F described below were prepared, and using these Extraction Liquids, green tea beverages of Examples 5 to 9 were prepared, and evaluations for the aftertaste and the balance of flavor were performed by sensory evaluations.

(Extraction Liquid E)

Tea leaves (Yabukita species, first flush tea produced in Kagoshima Prefecture) after plucking were subjected to Aracha process, and to a dry process (firing process) with a rotation drum type firing machine under the conditions of 210° C. of the setting temperature and 14 minutes of the dry time. The tea leaves were extracted under the conditions of 100 g of the tea leaves, 10 L of 85° C. hot water and 5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), and then further subjected to body-feeding of 0.2% by mass of acid-treated kieselguhr relatively to the liquid amount onto a filter plate in which 2 mm thick pre-coat was formed on a filtration carrier (FILTER PAD manufactured by Advantec MFS) with use of 700 g of the acid-treated kieselguhr per 1 m², to prepare Extraction E. At this time, the kieselguhr used was “RADIOLITE #300” manufactured by Showa Chemical Industry Co., Ltd. that was dipped in 40 fold amount of sulfuric acid solution (pH 1.5), and stood for 2 hours at ambient temperature with agitation, and then washed with water to pH 5 of the filtrate, and then dried with a rotation type drum.

(Extraction Liquid F)

Tea leaves (Yabukita species, third flush tea produced in Miyazaki Prefecture) after plucking were subjected to Aracha process with an oven-roasting method, and to a dry process (firing process) with a rotation drum type firing machine under the conditions of 255° C. of the setting temperature and 14 minutes of the dry time. The tea leaves were extracted under the conditions of 90 g of the tea leaves, 10 L of 75° C. hot water and 4 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), and then further subjected to body-feeding of 0.2% by mass of acid-treated kieselguhr relatively to the liquid amount onto a filter plate in which 2 mm thick pre-coat was formed on a filtration carrier (FILTER PAD manufactured by Advantec MFS) with use of 700 g of the acid-treated kieselguhr per 1 m², to prepare Extraction Liquid F. At this time, the kieselguhr used was “RADIOLITE #300” manufactured by Showa Chemical Industry Co., Ltd. that was dipped in 40 fold amount of sulfuric acid solution (pH 1.5), and stood for 2 hours at ambient temperature with agitation, and then washed with water to pH 5 of the filtrate, and then dried with a rotation type drum.

(Measurement For Particle Size)

1/10 Amount of each of the Extraction Liquids E and F was weighed, added with ascorbic acid in 400 ppm, and then added with sodium bicarbonate to adjust pH to 6.2, and added with ion-exchanged water to adjust the total amount to 1000 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C. For the solution, the particle size of the cumulative 90% by mass (D90) and the particle size of the cumulative 10% by mass (D10) were measured using laser diffraction equipment for measuring particle size distribution (“SALD-2100” manufactured by Shimadzu Corporation). The results of the measurements are shown in Table 4 described below.

TABLE 4

| | D10 | D90 |
|---|---|---|
| E | 1237.43 | 7930.10 |
| F | 1261.40 | 8000.80 |

(Blending)

Extraction Liquids E and F were blended in the ratios shown in Table 5, added with ascorbic acid in 400 ppm, and then added with sodium bicarbonate to adjust pH to 6.2, and added with ion-exchanged water to adjust the total amount to 10000 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C., to prepare the green tea beverages of Examples 5 to 9.

The results of the measurements for the components and pH of the green tea beverages of Examples 5 to 9 are shown in Table 6 described below. Each component and pH were measured in the same manner as described above.

TABLE 5

| | E | F | Total |
|---|---|---|---|
| Example 5 | 75 | 25 | 100 |
| Example 6 | 50 | 50 | 100 |
| Example 7 | 35 | 65 | 100 |
| Example 8 | 100 | 0 | 100 |
| Example 9 | 0 | 100 | 100 |

TABLE 6

| | Example 5 | Example 6 | Example 7 | Example 8 | Example 9 |
|---|---|---|---|---|---|
| Sugars/(Soluble Solid Content | 2.91 | 3.47 | 3.88 | 2.48 | 5.20 |
| Derived From Tea Leaves × 100) | | | | | |
| Sugars | 111.0 | 116.3 | 119.5 | 105.7 | 126.9 |
| Non-Reducing Sugar/Reducing | 4.07 | 5.16 | 5.81 | 2.99 | 7.32 |
| Sugar | | | | | |
| Electron-Localized Catechin | 722.1 | 643.3 | 596.0 | 800.9 | 485.6 |
| (ppm) | | | | | |
| pH | 6.2 | 6.2 | 6.2 | 6.2 | 6.2 |
| Electron-Localized | 18.94 | 19.17 | 19.35 | 18.76 | 19.90 |
| Catechin/(Soluble Solid Content | | | | | |
| Derived From Tea Leaves × 100) | | | | | |
| Furfural/Geraniol | 1.14 | 1.74 | 2.07 | 0.57 | 2.90 |
| Electron-Localized | 6.51 | 5.53 | 4.99 | 7.58 | 3.83 |
| Catechin/Sugars | | | | | |
| Total Catechin | 814.3 | 724.8 | 671.0 | 903.8 | 545.7 |
| Soluble Solid Content Derived | 0.38 | 0.34 | 0.31 | 0.43 | 0.24 |
| From Tea Leaves (%) | | | | | |
| Brix (%) | 0.44 | 0.39 | 0.36 | 0.49 | 0.29 |
| Total Catechin/(Soluble Solid | 21.36 | 21.60 | 21.78 | 21.17 | 22.36 |
| Content Derived From Tea | | | | | |
| Leaves × 100) | | | | | |
| D10 | 1243.50 | 1249.30 | 1253.10 | 1237.43 | 1261.40 |
| D90 | 7947.90 | 7965.65 | 7976.20 | 7930.10 | 8000.80 |
| Aftertaste | ⊚ | ⊚ | ○ | ○ | Δ |
| Balance Of Flavor | ○ | ⊚ | ⊚ | Δ | Δ |
| | Good balance of | Very good | Good balance of | Good | Defective |
| | flavor and good | balance of flavor | flavor and good | aftertaste but | aftertaste and |
| | aftertaste with | with concentration | aftertaste with | somewhat | somewhat |
| | concentration | feeling and | concentration | collapsed | collapsed |
| | feeling and | delicious taste, | feeling and | balance of | balance of |
| | delicious taste | and also good | delicious taste | flavor | flavor |
| | | aftertaste | | | |
| Total Evaluation | ○ | ⊚ | ○ | Δ | Δ |

(Evaluation Item)

The green tea beverages of Examples 5 to 9 were evaluated for the aftertaste and the balance of flavor.

(Evaluation Test)

The green tea beverages of Examples 5 to 9 were kept at 37° C. for 1.5 months, and then cooled to 5° C. The green tea beverages were tasted by 20 persons of general consumers drinking green teas at ordinary times, and given scores by the evaluations described below. The evaluations were performed wherein “⊚” indicates 3.5 or more, “∘” indicates 3 or more and less than 3.5, “Δ” indicates 2 or more and less than 3, and “x” indicates 1 or more and less than 2 of the average points of the 20 persons. The results thereof are shown in Table 6 described above.

<Aftertaste>

Particularly Good=4

Good=3

Usual=2

Bad=1

<Balance Of Flavor>

Particularly Good=4

Good=3

Slightly Collapsed=2

Collapsed=1

(Total Evaluation)

For any of Examples 5 to 7, excellent results were obtained, of which the total evaluation was “∘” or better.

On the other hand, for Examples 8 and 9, the results were “Δ,” which were slightly inferior to the results of Examples 5 to 7.

From the results of Example 8, it was found that if the value of the sugars/(soluble solid content derived from the tea leaves×100) is lowered, the balance of flavor is collapsed. From the results of Example 9, it was found that if the value of the sugars/(soluble solid content derived from the tea leaves×100) increases, the aftertaste is somewhat poor, and the balance of flavor also becomes worse.

From these results, if the sugars/(soluble solid content derived from the tea leaves×100) is in a range of 2.5 to 5.0, it is assumed that the range is a range that allows good aftertaste and good balance of flavor, and it was discovered that a green tea beverage of which the sugars/(soluble solid content derived from the tea leaves×100) is in this range, has good aftertaste and the balance of flavor even in a cold state.

<Evaluation Test 3>

Extraction Liquids G and H described below were prepared, and using these Extraction Liquids, green tea beverages of Examples 10 to 14 were prepared, and sensory evaluations with age were performed.

(Extraction Liquid G)

Tea leaves (Yabukita species, first flush tea produced in Kagoshima Prefecture) after plucking were subjected to Aracha process, and to a dry process (firing process) with a rotation drum type firing machine under the conditions of 265° C. of the setting temperature and 15 minutes of the dry time. The tea leaves were extracted under the conditions of 80 g of the tea leaves, 10 L of 80° C. hot water and 5 minutes of the extraction time. This extraction liquid was filtered with a stainless mesh (20 mesh) to remove the tea grounds, and then further filtered with stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), and then further subjected to body-feeding of 0.2% by mass of acid-treated kieselguhr relatively to the liquid amount onto a filter plate in which 2 mm thick pre-coat was formed on a filtration carrier (FILTER PAD manufactured by Advantec MFS) with use of 700 g of the acid-treated kieselguhr per 1 m², to prepare Extraction Liquid G. At this time, the kieselguhr used was “RADIOLITE #300” manufactured by Showa Chemical Industry Co., Ltd. that was dipped in 40 fold amount of sulfuric acid solution (pH 1.5), and stood for 2 hours at ambient temperature with agitation, and then washed with water to pH 5 of the filtrate, and then dried with a rotation type drum.

(Extraction Liquid H)

Tea leaves (Yabukita species, first flush tea produced in Shizuoka Prefecture) after plucking were subjected to Aracha process with an oven-roasting method, and to a dry process (firing process) with a rotation drum type firing machine under the conditions of 115° C. of the setting temperature and 32 minutes of the dry time. The tea leaves were extracted under the conditions of 110 g of the tea leaves, 10 L of 90° C. hot water and 4 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), and then further subjected to body-feeding of 0.2% by mass of acid-treated kieselguhr relatively to the liquid amount onto a filter plate in which 2 mm thick pre-coat was formed on a filtration carrier (FILTER PAD manufactured by Advantec MFS) with use of 700 g of the acid-treated kieselguhr per 1 m², to prepare Extraction Liquid H. At this time, the kieselguhr used was “RADIOLITE #300” manufactured by Showa Chemical Industry Co., Ltd. that was dipped in 40 fold amount of sulfuric acid solution (pH 1.5), and stood for 2 hours at ambient temperature with agitation, and then washed with water to pH 5 of the filtrate, and then dried with a rotation type drum.

(Measurement for Particle Size)

1/10 Amount of each of the Extraction Liquids G and H was weighed, added with ascorbic acid in 400 ppm, and then added with sodium bicarbonate to adjust pH to 6.2, and added with ion-exchanged water to adjust the total amount to 1000 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C. For the solution, the particle size of the cumulative 90% by mass (D90) and the particle size of the cumulative 10% by mass (D10) were measured using laser diffraction equipment for measuring particle size distribution (“SALD-2100” manufactured by Shimadzu Corporation). The results of the measurements are shown in Table 7 described below.

TABLE 7

| | D10 | D90 |
|---|---|---|
| G | 1261.70 | 8000.10 |
| H | 1237.60 | 7931.10 |

(Blending)

Extraction Liquids G and H were blended in the ratios shown in Table 8, added with ascorbic acid in 400 ppm, and then added with sodium bicarbonate to adjust pH to 6.2, and added with ion-exchanged water to adjust the total amount to 10000 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C., to prepare the green tea beverages of Examples 10 to 14. The results of the measurements for the components and pH of the green tea beverages of Examples 10 to 14 are shown in Table 9 described below. Each component and pH were measured in the same manner as described above.

TABLE 8

| | G | H | Total |
|---|---|---|---|
| Example 10 | 85 | 15 | 100 |
| Example 11 | 50 | 50 | 100 |
| Example 12 | 15 | 85 | 100 |
| Example 13 | 100 | 0 | 100 |
| Example 14 | 0 | 100 | 100 |

TABLE 9

| | | Example 10 | Example 11 | Example 12 | Example 13 | Example 14 |
|---|---|---|---|---|---|---|
| Electron-Localized | | 15.64 | 17.87 | 19.62 | 14.48 | 20.26 |
| Catechin/(Soluble Solid | | | | | | |
| Content Derived From Tea | | | | | | |
| Leaves × 100) | | | | | | |
| Sugars | | 118.9 | 135.9 | 152.8 | 111.6 | 160.1 |
| Non-Reducing Sugar/Reducing | | 6.95 | 5.09 | 3.22 | 7.75 | 2.42 |
| Sugar | | | | | | |
| Sugars/(Soluble Solid Content | | 4.07 | 4.09 | 4.11 | 4.06 | 4.12 |
| Derived From Tea | | | | | | |
| Leaves × 100) | | | | | | |
| Electron-Localized | | 3.84 | 4.29 | 4.73 | 3.65 | 4.92 |
| Catechin/Sugars | | | | | | |
| Furfural/Geraniol | | 2.50 | 1.72 | 0.96 | 2.94 | 0.53 |
| Electron-Localized Catechin | | 456.7 | 593.2 | 729.7 | 398.2 | 788.2 |
| (ppm) | | | | | | |
| pH | | 6.2 | 6.2 | 6.2 | 6.2 | 6.2 |
| Total Catechin (ppm) | | 522.2 | 671.7 | 821.1 | 458.2 | 885.1 |
| Soluble Solid Content Derived | | 0.29 | 0.33 | 0.37 | 0.26 | 0.39 |
| From Tea Leaves (%) | | | | | | |
| Brix (%) | | 0.33 | 0.38 | 0.42 | 0.31 | 0.44 |
| Total Catechin/(Soluble Solid | | 17.88 | 20.23 | 22.08 | 16.66 | 22.75 |
| Content Derived From Tea | | | | | | |
| Leaves × 100) | | | | | | |
| D10 | | 1252.80 | 1249.90 | 1242.30 | 1261.70 | 1237.60 |
| D90 | | 7977.20 | 7965.70 | 7948.20 | 8000.10 | 7931.10 |
| Change | Aftertaste | ○ | ⊚ | ○ | Δ | Δ |
| with age | Initial Odor | ○ | ○ | Δ | ○ | Δ |
| | Middle Odor | Δ | ○ | ○ | Δ | ○ |
| | Odor remaining | ○ | ○ | ○ | Δ | Δ |
| | in the mouth | | | | | |
| | Nutritious taste | ○ | ○ | ○ | ○ | Δ |
| | Balance Of | ○ | ○ | ○ | Δ | Δ |
| | Flavor | Appropriate | Appropriate | Astringent | Somewhat | Somewhat |
| | | astringent | astringent | taste, sweet | defective | defective |
| | | taste and | taste and | taste and | aftertaste | aftertaste |
| | | sweet taste | sweet taste | concentration | and balance | and balance |
| | | sensed, and | sensed, and | feeling | of flavor as | of flavor as |
| | | Good balance | Good balance | sensed, and | a beverage | a beverage |
| | | of flavor as a | of flavor as a | Good | collapsed | collapsed |
| | | delicious and | refreshing | balance of | | |
| | | refreshing | beverage | flavor as a | | |
| | | beverage | having | refreshing | | |
| | | | appropriate | beverage | | |
| | | | concentration | | | |
| | | | feeling | | | |
| | Appearance | ○ | ○ | ○ | ○ | Δ |

| | | | | | |
|---|---|---|---|---|---|
| Total Evaluation | ○ | ○ | ○ | Δ | Δ |

(Evaluation Item)

The green tea beverages of Examples 10 to 14 were evaluated for the aftertaste, the initial odor, the middle odor, the odor remaining in the mouth, the nutritious taste, the balance of flavor and the appearance.

(Evaluation Test)

The green tea beverages of Examples 10 to 14 were kept at 25° C. for 9 months, and then returned to ordinary temperature. The green tea beverages were tasted by 20 persons of general consumers drinking green teas at ordinary times, and given scores by the evaluations described below. The evaluations were performed wherein “⊚” indicates 3.5 or more, “∘” indicates 3 or more and less than 3.5, “Δ” indicates 2 or more and less than 3, and “x” indicates 1 or more and less than 2 of the average points of the 20 persons. The results thereof are shown in Table 9 described above.

<Aftertaste>

Particularly Good-=4

Good=3

Usual=2

Bad=1

<Initial Odor>

Particularly Strong=4

Strong=3

Present=2

Weak=1

<Middle Odor>

Particularly Strong=4

Strong=3

Present=2

Weak=1

<Odor Remaining in the Mouth>

Particularly Strong=4

Strong=3

Present=2

Weak=1

<Nutritious Taste>

Particularly Good=4

Good=3

Usual-2

Weak=1

<Balance of Flavor>

Particularly Good-4

Good=3

Slightly Collapsed-2

Collapsed=1

<Appearance (Color Change)>

Small Change=4

Somewhat Changing=3

Changing=2

Significant Change=1

(Total Evaluation)

The average points of the evaluation tests for the aftertaste, the initial odor, the middle odor, the odor remaining in the mouth, the nutritious taste, the balance of flavor and the appearance were calculated, and the total evaluations were performed wherein “⊚” indicates 3.5 or more, “∘” indicates 3 or more and less than 3.5, “Δ” indicates 2 or more and less than 3, and “x” indicates 1 or more and less than 2 of the average point.

For any of Examples 10 to 12, excellent results were obtained, of which the total evaluation was “∘” or better.

On the other hand, for Examples 13 and 14, the results were “Δ,” which were slightly inferior to the results of Examples 10 to 12.

From the results of Example 13, it was found that if the value of the electron-localized catechin/(soluble solid content derived from the tea leaves×100) is lowered, the aftertaste becomes worse and the balance of flavor is collapsed. From the results of Example 14, it was found that if the value of the electron-localized catechin/(soluble solid content derived from the tea leaves×100) increases, the balance of flavor becomes worse, and the appearance also becomes worse.

From these results, it is assumed that the value of the electron-localized catechin/(soluble solid content derived from the tea leaves×100) being 15.0 to 20.0, is a range that allows good aftertaste and balance of flavor even with age, and it was discovered that a green tea beverage of which the value of the electron-localized catechin/(soluble solid content derived from the tea leaves×100) is in this range, has nutritious taste and odor note even in a cold state.

1. A green tea beverage packed in a container of which a sugar concentration, which is the sum of a reducing sugar concentration and a non-reducing sugar concentration, is 75 ppm to 250 ppm, a ratio of the non-reducing sugar concentration relatively to the reducing sugar concentration (non-reducing sugar/reducing sugar) is 2.0 to 8.0, and a particle size of the cumulative 90% by mass (D90) is 2500 μm or more.

2. The green tea beverage packed in a container according to claim 1, wherein a content ratio of furfural relatively to geraniol (furfural/geraniol) is 0.5 to 3.0.

3. The green tea beverage packed in a container according to claim 1, wherein a ratio of sugars to a soluble solid content derived from tea leaves (sugars/(soluble solid content derived from the tea leaves×100)) is 2.5 to 5.0.

4. The green tea beverage packed in a container according to claim 1, wherein a ratio of a concentration of electron-localized catechin relatively to the soluble solid content derived from tea leaves (electron-localized catechin/(soluble solid content derived from the tea leaves×100)) is 15.0 to 20.0.

5. A method of manufacturing a green tea beverage packed in a container, comprising:
adjusting a sugar concentration in a green tea beverage, which is the sum of a reducing sugar concentration and a non-reducing sugar concentration, to 75 ppm to 250 ppm;
adjusting a ratio of the non-reducing sugar concentration relatively to the reducing sugar concentration (non-reducing sugar/reducing sugar) to 2.0 to 8.0; and
adjusting a particle size of the cumulative 90% by mass (D90) to 2500 μm or more.

6. The method of manufacturing a green tea beverage packed in a container according to claim 5, wherein the particle size of the cumulative 90% by mass (D90) is adjusted by filtration.

7. The method of manufacturing a green tea beverage packed in a container according to claim 6, wherein the particle size of the cumulative 90% by mass (D90) is adjusted by filter cake filtration using either one or both of a filter media containing silica content and a porous media.

8. A method of improving flavor of a green tea beverage packed in a container, comprising:
adjusting a sugar concentration in a green tea beverage, which is the sum of a reducing sugar concentration and a non-reducing sugar concentration, to 75 ppm to 250 ppm;
adjusting a ratio of the non-reducing sugar concentration relatively to the reducing sugar concentration (non-reducing sugar/reducing sugar) to 2.0 to 8.0; and
adjusting a particle size of the cumulative 90% by mass (D90) to 2500 μm or more.
